(19) United States
(12) Patent Application Publication
(10) Pub. No.: US 2013/0107011 A1
(43) Pub. Date: May 2, 2013

(54) STEREO CAMERA MODULE AND STEREO CAMERA

(71) Applicants: Kang Joo Kim, Yongin (KR); Soon Seok Kang, Yongin (KR)

(72) Inventors: Kang Joo Kim, Yongin (KR); Soon Seok Kang, Yongin (KR)

(73) Assignee: SAMSUNG ELECTROMECHANICS CO., LTD., Suwon (KR)

(21) Appl. No.: 13/357,047

(22) Filed: Jan. 24, 2012

(30) Foreign Application Priority Data
Oct. 28, 2011 (KR) 10-2011-0111498

(51) Int. Cl. H04N 13/02

(52) U.S. Cl. 348/47; 348/E13.074

(57) ABSTRACT

There is provided a stereo camera module, including: a camera unit including a first camera and a second camera disposed to be separated from each other by a predetermined interval to receive a left image and a right image, respectively; and a correction coefficient storing unit storing a correction coefficient indicating a degree to which the first camera and the second camera deviate from a predetermined alignment state.

### CROSS-REFERENCE TO RELATED APPLICATIONS

This application claims the priority of Korean Patent Application No. 10-2011-0111498 filed on Oct. 28, 2011, in the Korean Intellectual Property Office, the disclosure of which is incorporated herein by reference.

### BACKGROUND OF THE INVENTION

1. Field of the Invention

The present invention relates to a stereo camera module and a stereo camera including a correction coefficient storing unit storing a correction coefficient indicating a degree to which a camera unit deviates from an alignment state.

2. Description of the Related Art

As the popularity of 3D-related technologies increases, technologies such as 3D games, 3D cameras, and the like, have rapidly developed, with 3D display technology in the lead. In accordance with the development, the 3D technology begins to be generalized even in portable smart phones and the manufacturing of a stereo camera module and a correction technology has come to be required. Further, the manufacturing of stereo camera modules has become an issue, due to the large market therefor. In recent years, 3D images have been captured by using the stereo camera module and the captured 3D images have been viewed with a 3D display device, in general.

The largest factor to allow for the experience of a 3D effect, is the difference in spatial perception occurring between left and right retinas, generated when left and right eyes view a single object from different directions. As one method for acquiring a 3D image by using the effect of the difference, a method of using a stereo camera module including a pair of left and right cameras when an image is captured is used. According to this method, since the left camera and the right camera capture a subject from the same positions as an observer's actual eyes, a natural 3D image can be acquired.

However, in addition to a problem which occurs within a single sensor itself at the time of manufacturing the camera module, when the sensors of both cameras in the stereo camera module are misaligned with each other, a natural 3D image viewed by actual eyes cannot be acquired due to a disparity between an image acquired by using the left camera and an image acquired by using the right camera, causing the stereo camera module to malfunction and causing significantly expensive damage. Therefore, a lot of manufacturers are developing methods and devices aimed at correcting image distortions in stereo cameras in order to solve the foregoing problem.

### SUMMARY OF THE INVENTION

An aspect of the present invention provides a stereo camera module and a stereo camera allowing for reduced manufacturing costs and facilitating the correction of an image in a stage subsequent to the stereo camera module by removing a correction integrated circuit (IC).

According to an aspect of the present invention, there is provided a stereo camera module, including: a camera unit including a first camera and a second camera disposed to be separated from each other by a predetermined interval to receive a left image and a right image, respectively; and a correction coefficient storing unit storing a correction coefficient indicating a degree to which the first camera and the second camera deviate from a predetermined alignment state.

The correction coefficient may be extracted and stored at a time of manufacturing the stereo camera module.

The correction coefficient may be extracted from a reference image captured at a time of manufacturing the stereo camera module.

The first camera and the second camera may be disposed to be separated from each other by a distance equal to a distance between human eyes.

According to another aspect of the present invention, there is provided a stereo camera, including: a stereo camera module including a camera unit receiving a left image and a right image and a correction coefficient storing unit storing a correction coefficient indicating a degree of deviation of the camera unit from an alignment state, therein; and a control unit creating a stereoscopic image from the correction coefficient, the left image, and the right image.

The stereo camera may further include a display unit displaying the stereoscopic image.

The control unit may include a processor unit performing predetermined image processing on the stereoscopic image.

The processor unit may include: an interface section receiving the left image and the right image from the stereo camera module; an image correcting section correcting the left image and the right image in accordance with the correction coefficient; and an image matching section creating the stereoscopic image from the corrected left image and the corrected right image.

The processor unit may further include an image storing section storing the left image and the right image received from the stereo camera module.

The left image and the right image may be transmitted directly to the image storing section from the interface section.

The interface section may be a mobile industry processor interface (MIPI).

The image correction unit may correct the left image and the right image by using a 3D engine.

The 3D engine may be OpenGL or DirectX.

The image matching section may create the stereoscopic image by using a hardware accelerator of the processor unit.

The image matching section may create the stereoscopic image from the left image and the right image by using a side-by-side method.

The control unit may include: a correction IC creating the stereoscopic image by receiving the correction coefficient, the left image, and the right image from the stereo camera module to perform predetermined image processing thereon; and a processor unit performing a predetermined image processing operation with respect to the stereoscopic image.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a stereo camera module according to an embodiment of the present invention;

FIG. 2 is a block diagram of a stereo camera according to an embodiment of the present invention; and

FIG. 3 is a block diagram of a stereo camera according to another embodiment of the present invention.

### DETAILED DESCRIPTION OF THE INVENTION

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

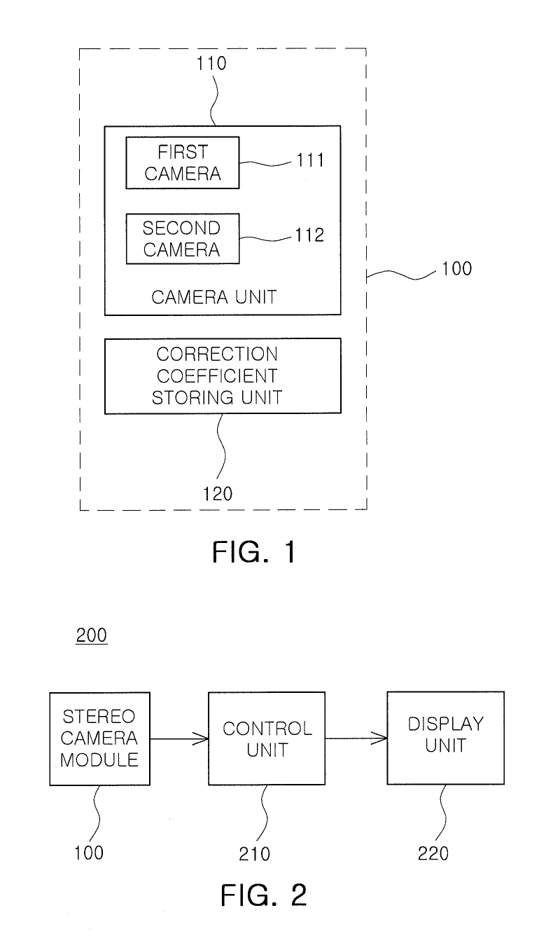

FIG. 1 is a block diagram of a stereo camera module according to an embodiment of the present invention.

As shown in FIG. 1, a stereo camera module 100 according to the embodiment of the present invention may include a camera unit 110 and a correction coefficient storing unit 120.

The camera unit 110 according to the embodiment of the present invention may include a first camera 111 and a second camera 112 separated from each other at a predetermined interval to receive a left image and a right image, respectively. That is, a stereoscopic image according to the embodiment of the present invention is generated through a scheme in which the first camera 111 receives the left image and the second camera 112 receives the right image to create the stereoscopic image, rather than a scheme of creating a pair of left image and right image by performing image signal processing with respect to a single 2D image. Thus, a stereoscopic image having a more natural and stable 3D effect may be created. The correction coefficient storing unit 120 according to the embodiment of the present invention may have a correction coefficient indicating a degree to which the first camera and the second camera of the camera unit 110 deviate from an alignment state. In this case, the correction coefficient storing unit 120 may be a separate memory. In this case, the alignment state represents positional states of the first camera 111 and the second camera 112, enabling the stereoscopic image to be naturally and stably obtained when the stereoscopic image is created without correction from the left image received by the first camera 111 and the right image received by the second camera 112. In a case in which the first camera and the second camera deviate from the alignment state, when an observer views a stereoscopic image created without correction, the observer may experience a severe adverse reaction such as a headache, dizziness, or the like, and as a result, it is difficult for the observer to view a stereoscopic image obtained in an unaligned state for a long time. The first camera 111 and the second camera 112 may unavoidably deviate from the alignment state to a certain degree, due to limitations in a practical manufacturing process and it is important to extract a correction coefficient for correcting the deviation state.

As described above, the stereo camera module 100 according to the embodiment of the present invention may include the camera unit 110 and the correction coefficient storing unit 120 storing the correction coefficient therein, unlike a configuration in which only a left camera and a right camera are provided within a camera module and a correction integrated circuit (IC) disposed in a stage subsequent to the stereo camera module extracts and stores a correction coefficient. According to the embodiment of the present invention, since the correction coefficient is stored in the correction coefficient storing unit 120 positioned in the camera module, a component for separately extracting and storing the correction coefficient is not required in the stage subsequent to the camera module.

Further, according to the embodiment of the present invention, the correction coefficient stored in the correction coefficient storing unit 120 may be extracted and stored at the time of manufacturing the stereo camera module 100. When the stereo camera module is mounted on a smart phone, for example, in the case of a comparative example, a correction coefficient is stored in a correction IC disposed in a stage subsequent to the camera module by capturing an image for image correction and extracting the correction coefficient therefrom at the time of manufacturing the smart phone. That is, in the comparative example, a camera module configuration may be simplified while the correction coefficient is extracted from the correction IC disposed in a stage subsequent to the camera module. However, in the case of the stereo camera module 100 according to the embodiment of the present invention, a correction limitation may be handled with only the camera module by extracting and storing a correction coefficient at the time of manufacturing the camera module, rather than at the time of manufacturing a terminal having the camera module mounted thereon. According to the embodiment of the present invention, the correction coefficient may be extracted from a reference image captured at the time of manufacturing the stereo camera module. The correction coefficient may be extracted by comparing a reference image captured when sensors of the first camera 111 and the second camera 112 of the camera unit 110 in the stereo camera module are properly arranged with a reference image captured at the time of manufacturing the stereo camera module.

More specifically, the correction coefficient may be acquired by using a pinhole camera module. That is, the correction coefficient may be extracted by projecting an image onto a projection plane with respect to the left image and the right image. However, in addition to this method, the correction coefficient may be extracted by a person having ordinary skill in the art through various methods within the scope of technique commonly known in the manufacturing of the stereo camera module. Since the correction coefficient is caused by the deviation from the alignment state generated at the time of manufacturing the camera module, the correction coefficient needs to be extracted for each camera module.

The extracted correction coefficient is received from a processor unit 310, to be described later, whereby the degree to which the first camera 111 and the second camera 112 of the camera unit 110 in the camera module deviate from the alignment state may be determined, and based on the determination, the deviation state may be corrected to the alignment state.

Further, according to the embodiment of the present invention, the first camera 111 and the second camera 112 may be spaced apart from each other by a distance equal to a distance between human eyes. The cameras receiving image information are disposed apart from each other by a distance equal to that between human eyes, to thereby allow for the obtainment of an image having a natural 3D effect when viewed by a viewer, as if the viewer's actual eyes were seeing the image.

FIG. 2 is a block diagram of a stereo camera 200 according to an embodiment of the present invention.

As shown in FIG. 2, the stereo camera 200 according to the embodiment of the present invention may include the stereo camera module 100, a control unit 210, and a display unit 220.

The stereo camera module 100 according to the embodiment of the present invention is as described above.

The control unit 210 according to the embodiment of the present invention may create the stereoscopic image from the correction coefficient, the left image, and the right image. In particular, the control unit 210 according to the embodiment of the present invention may include the processor unit 310 performing a predetermined image processing operation with respect to the stereoscopic image without the correction IC, or the control unit 210 may include the correction IC (not shown) creating the stereoscopic image by receiving the correction coefficient, the left image, and the right image from the stereo camera module to perform predetermined image processing and the processor unit (not shown) performing the predetermined image processing operation with respect to the stereoscopic image.

The display unit 220 according to the embodiment of the present invention may display the stereoscopic image and may be configured as a 3D LCD.

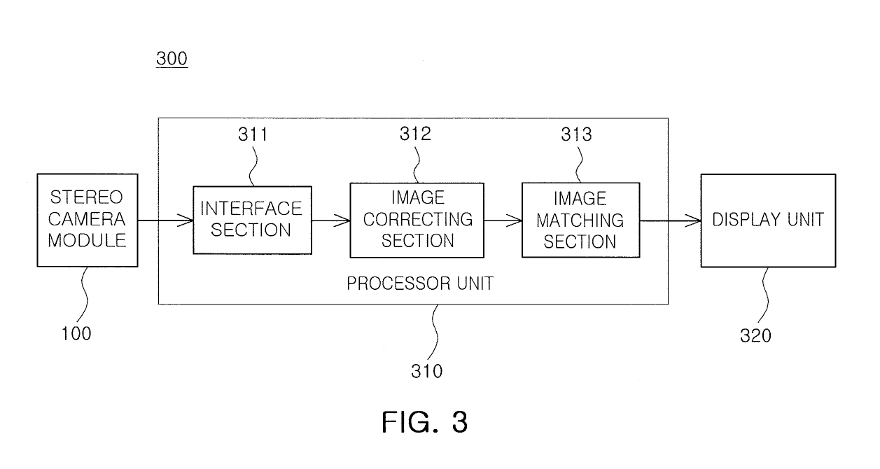

FIG. 3 is a block diagram of a stereo camera 300 according to another embodiment of the present invention.

The stereo camera 300 according to the embodiment of the present invention may include the stereo camera module 100, the processor unit 310, and a display unit 320.

The stereo camera module 100 according to the embodiment of the present invention is as described above.

The processor unit 310 according to the embodiment of the present invention may create the stereoscopic image by receiving the correction coefficient, the left image, and the right image from the stereo camera module 100 and may include an interface section 311, an image correcting section 312, an image matching section 313, and an image storing section (not shown).

The interface section 311 according to the embodiment of the present invention may receive the left image and the right image from the stereo camera module 100. Further, the interface section 311 may be a mobile industry processor interface (MIPI). In this case, the MIPI refer to a new standard of a serial interface connecting hardware and software between a processor and a peripheral device. The MIPI may connect the processor unit 310 and the stereo camera module 100 with each other to receive the left image and the right image from the stereo camera module 100 in the embodiment of the present invention.

Further, the processor unit 310 according to the embodiment of the present invention may further include the image storing section (not shown) which stores the left image and the right image received from the stereo camera module 100. In this case, the image storing section may be not a separate memory and a previously defined area within a system memory in the processor unit may be used for the image storing section.

Furthermore, the left image and the right image according to the embodiment of the present invention may be directly transmitted from the interface section 311 to the image storing section. That is, the left image and the right image are inputted from the interface section 311 to be transmitted to the image storing section by direct memory access (DMA). As described above, the images are transmitted by the DMA, such that the images are stored in the system memory of the processor unit 310 without involving a CPU of the processor unit and the overall performance of the processor unit 310 may not be affected.

The image correcting section 312 according to the embodiment of the present invention may correct the left image and the right image according to the correction coefficient. More specifically, the image correcting section 312 according to the embodiment of the present invention may correct the left mage and the right image by using a 3D engine. In this case, the left image and the right image are accumulated in the image storing section as described above and the image correcting section 312 may read the correction coefficient directly from the correction coefficient storing unit 120 of the stereo camera module 100. The image correcting section 312 may correct the left image and the right image from the correction coefficient indicating a degree to which the first camera 111 and the second camera 112 are deviated, that is, a degree to which the first camera 111 and the second camera 112 deviate from the alignment state, in such a manner that the first camera 111 and the second camera 112 are in the alignment state. In this case, the 3D engine used in the image correcting section 312 may be a 3D engine using a graphic hardware acceleration function in the processor unit 310, such as OpenGL or DirectX. Since the image correcting section 312 performs correction by using the graphic hardware acceleration function which is originally existed in the processor unit, the provision of separate hardware may be not required and further, no load is imparted to the processor unit 310.

The image matching section 313 according to the embodiment of the present invention may create the stereoscopic image from the corrected left image and the corrected right image. More specifically, the image matching section 313 may create the stereoscopic image by using a hardware accelerator of the processor unit 310. The hardware accelerator is originally existed in the processor unit 310. Thus, when image matching is performed by using the hardware accelerator, there is no concern about deteriorating an operation of the processor unit 310 and the provision of separate hardware is not required.

The image matching section 313 according to the embodiment of the present invention may create the stereoscopic image from the left image and the right image by using a side-by-side method.

Methods of creating the stereoscopic image may include methods of creating the left image and the right image as a single stream and methods of creating the left image and the right image as two streams. The methods of creating the left image and the right image as a single stream may include the side-by-side method, a top-bottom method, a line interleave method, a column interleave method, and a checker board method. The methods of creating the left image and the right image as two streams may include a dual stream method and a tile format method. Among these methods, the side-by-side method is a method of creating a stereoscopic image by connecting the left image and the right image side by side in a horizontal direction to configure a single frame image. However, in addition to the side-by-side method, those skilled in the art may create the stereoscopic image from the corrected left image and the corrected right image by using various other methods within a well known technical scope such as the above methods.

The display unit 320 according to the embodiment of the present invention displays the stereoscopic image created by the image matching section 313 to allow an observer to view the stereoscopic image actually. In this case, the display unit 320 may be a 3D LCD monitor.

As described above, a stereo camera according to the comparative example may extract and store the correction coefficient by additionally including the correction IC in a stage subsequent to the stereo camera module, correct the left image and the right image received from the camera module based on the correction coefficient, and create the stereoscopic image by matching the corrected left image and the corrected right image. Unlike the configuration of the stereo camera according to the comparative example, in the stereo camera 300 according to the embodiment of the present invention, since the correction coefficient is extracted in the manufacturing process of the stereo camera module 100 and stored in the stereo camera module 100, it is not necessary to separately extract the correction efficient in a stage subsequent to the stereo camera module 100 at the time of manufacturing a terminal including the stereo camera module.

Further, as compared to the case of the comparative example, in which image correction and image matching are performed in the correction IC, since the stereo camera 300 according to the embodiment of the present invention may use the system memory and the hardware acceleration function, a load of such an extent as to affect a predetermined image processing function, the original function of the processor unit 310, may not be imparted. That is, since the stereo camera 300 may perform image correction and image matching by using the processor unit 310, the stereo camera 300 does not need to have the correction IC of the comparative example. As a result, the size of the stereo camera 300 according to the embodiment of the present invention may be reduced, a manufacturing cost may be saved, and power consumption may also be reduced.

Unlike the comparative example, in which only the left camera and the right camera are provided in the stereo camera module, the correction coefficient storing unit 120 is additionally provided in the stereo camera module 100 according to the embodiment of the present invention as described above. However, since the stored correction coefficient is extracted for each module at the time of manufacturing the stereo camera module, a separate processor does not need to be installed in the stereo camera module in order to extract the correction coefficient. In addition, since it is enough that the correction coefficient storing unit 120 may store the extracted correction coefficient as simple data, there no concern about the occupation of a large space within the stereo camera module. That is, no additional complicated hardware is required in implementing the stereo camera module 100 according to the embodiment of the present invention.

A stereo camera (not shown) according to another embodiment of the present invention may include the stereo camera module 100 including the camera unit 110 receiving the left image and right image and the correction coefficient storing unit 120 storing the correction coefficient indicating a degree of deviation of the camera unit from the alignment state, a correction IC (not shown) creating the stereoscopic image by receiving the correction coefficient, the left image, and the right image from the stereo camera module 100 to perform predetermined image processing, and the display unit 320 displaying the stereoscopic image. In addition, in this case, the stereo camera may further include a processor unit (not shown) receiving the stereoscopic image from the correction IC and performing predetermined image processing therefor to thereby transfer the processed stereoscopic image to the display unit 320.

The stereo camera (not shown) according to another embodiment of the present invention is the same as the stereo camera 300 according to the embodiment of the present invention shown in FIG. 3 in that the stereo camera module 100 storing the correction coefficient which indicates the degree of deviation from the alignment state in the correction coefficient storing unit 120 during the manufacturing process is used.

However, the stereo camera (not shown) according to another embodiment of the present invention may include the correction IC performing image correction and image matching by receiving only the correction coefficient from the correction coefficient storing unit 120 of the stereo camera module, in which the correction coefficient is extracted and stored. That is, in the stereo camera (not shown) according to another embodiment of the present invention, the correction IC is not removed and only performs image correction and image matching, unlike the correction IC of the comparative example, which extracts and stores the correction coefficient at the time of manufacturing the terminal including the stereo camera module, corrects images from the correction coefficient, and matches the images.

As described above, image matching and image correction may be performed by using the hardware and function of the processor unit without the correction IC, and also, the correction IC may perform simple functions such as the image correction and image matching.

Since the stereo camera (not shown) according to another embodiment of the present invention does not use the hardware and function of the processor unit unlike the stereo camera 300 according to the embodiment of the present invention, the stereo camera may create the stereoscopic image without affecting the image processing function of the processor unit. Further, since the correction IC performs an image correcting operation by reading the correction coefficient which is already stored, a component directly extracting and storing the correction coefficient may not be required. Accordingly, the correction IC of the stereo camera according to another embodiment of the present invention may have a reduced size and a simplified structure.

The stereo camera 300 according to the embodiment of the present invention extracts the correction coefficient from the time of manufacturing the stereo camera module 100 and stores the correction coefficient in the correction coefficient storing unit 120 to thereby accurately transfer a camera sensor characteristic of the stereo camera module 100 to a terminal manufacturer when the terminal using the camera module is manufactured. Further, since it is not necessary to newly extract the correction coefficient, correction limitations may be handled by using only the stereo camera module. In addition, since the correction IC is not used or a simplified correction IC may be used, the manufacturing cost of the stereo camera may be saved.

As described above, the size of the stereo camera 300 according to the embodiment of the present invention may be decreased, the manufacturing cost thereof may be saved, and the power consumption thereof may be reduced, and as a result, the stereo camera 300 can be utilized in a cellular phone terminal using the stereo camera, a TV set using the stereo camera, an image security solution using the stereo camera, and a video conference solution using the stereo camera.

As set forth above, according to the embodiments of the present invention, a correction IC can be removed to thereby reduce a manufacturing cost and facilitate image correction in a stage subsequent to a stereo camera module.

While the present invention has been shown and described in connection with the embodiments, it will be apparent to those skilled in the art that modifications and variations can be made without departing from the spirit and scope of the invention as defined by the appended claims.

What is claimed is:

1. A stereo camera module, comprising:
a camera unit including a first camera and a second camera disposed to be separated from each other by a predetermined interval to receive a left image and a right image, respectively; and
a correction coefficient storing unit storing a correction coefficient indicating a degree to which the first camera and the second camera deviate from a predetermined alignment state.

2. The stereo camera module of claim 1, wherein the correction coefficient is extracted and stored at a time of manufacturing the stereo camera module.

3. The stereo camera module of claim 1, wherein the correction coefficient is extracted from a reference image captured at a time of manufacturing the stereo camera module.

4. The stereo camera module of claim 1, wherein the first camera and the second camera are disposed to be separated from each other by a distance equal to a distance between human eyes.

5. A stereo camera, comprising:
a stereo camera module including a camera unit receiving a left image and a right image and a correction coefficient storing unit storing a correction coefficient indicating a degree of deviation of the camera unit from an alignment state, therein; and
a control unit creating a stereoscopic image from the correction coefficient, the left image, and the right image.

6. The stereo camera of claim 5, further comprising a display unit displaying the stereoscopic image.

7. The stereo camera of claim 5, wherein the control unit includes a processor unit performing predetermined image processing on the stereoscopic image.

8. The stereo camera of claim 7, wherein the processor unit includes:
an interface section receiving the left image and the right image from the stereo camera module;
an image correcting section correcting the left image and the right image in accordance with the correction coefficient; and
an image matching section creating the stereoscopic image from the corrected left image and the corrected right image.

9. The stereo camera of claim 8, wherein the processor unit further includes an image storing section storing the left image and the right image received from the stereo camera module.

10. The stereo camera of claim 9, wherein the left image and the right image are transmitted directly to the image storing section from the interface section.

11. The stereo camera of claim 8, wherein the interface section is a mobile industry processor interface (MIPI).

12. The stereo camera of claim 8, wherein the image correction unit corrects the left image and the right image by using a 3D engine.

13. The stereo camera of claim 12, wherein the 3D engine is OpenGL or DirectX.

14. The stereo camera of claim 8, wherein the image matching section creates the stereoscopic image by using a hardware accelerator of the processor unit.

15. The stereo camera of claim 8, wherein the image matching section creates the stereoscopic image from the left image and the right image by using a side-by-side method.

16. The stereo camera of claim 5, wherein the control unit includes:
a correction integrated circuit (IC) creating the stereoscopic image by receiving the correction coefficient, the left image, and the right image from the stereo camera module to perform predetermined image processing thereon; and
a processor unit performing a predetermined image processing operation with respect to the stereoscopic image.
